(19) United States
(12) Patent Application Publication
(10) Pub. No.: US 2004/0094355 A1
(43) Pub. Date: May 20, 2004

(54) Cohlear implant communicator

(76) Inventors: Michael Goorevich, Dulwich Hill (AU); Colin Irwin, Basel (CH); Brett Anthony Swanson, West Ryde (AU)

Correspondence Address: Tiberiu Weisz, Gottlieb Rackman & Reisman, 270 Madison Avenue, New York, NY, 10016-0601, US

(21) Appl. No.: 10/250,880

(22) PCT Filed: Jan. 10, 2002
(86) PCT No.: PCT/AU02/00026

(30) Foreign Application Priority Data
Jan. 10, 2001 (AU) PR 2476

(51) Int. Cl. H04R 25/00

(52) U.S. Cl. 181/129

(57) ABSTRACT

A software library for controlling tissue-stimulating prostheses is provided. A plurality of software modules are stored in the library, enabling users to input abstract, high-level commands, for example at a psychophysical level, which do not require detailed knowledge of system-level operating requirements of the prosthesis. Upon receipt of such commands, the software library is accessed in order to obtain software modules to carry out the commands, in order to generate a software command set. The software command set is communicated to the processor of the prosthesis, or directly to the prosthesis.

### FIELD OF THE INVENTION

The present invention relates to a software library that can be used in the creation of a software command set for transmission to a tissue-stimulating prosthesis, such as a cochlear implant.

### BACKGOUND OF THE INVENTION

In many people who are profoundly deaf, the reason for deafness is absence of, or destruction of, the hair cells in the cochlea which transduce acoustic signals into nerve impulses. These people are thus unable to derive suitable benefit from conventional hearing aid systems, no matter how loud the acoustic stimulus is made, because there is damage to, or an absence of the mechanism for nerve impulses to be generated from sound in the normal manner.

It is for this purpose that cochlear implant systems have been developed. Such systems bypass the hair cells in the cochlea and directly deliver electrical stimulation to the auditory nerve fibres, thereby allowing the brain to perceive a hearing sensation resembling the natural hearing sensation normally delivered to the auditory nerve. U.S. Pat. No. 4,532,930, the contents of which are incorporated herein by reference, provides a description of one type of traditional cochlear implant system.

Typically, cochlear implant systems have consisted of essentially two components, an external component commonly referred to as a processor unit and an internal implanted component commonly referred to as a stimulator/receiver unit Traditionally, both of these components have cooperated together to provide the sound sensation to a user.

The external component has traditionally consisted of a microphone for detecting sounds, such as speech and environmental sounds, a speech processor that converts the detected sounds into a coded signal, a power source such as a battery, and an external transmitter coil.

The coded signal output by the speech processor is transmitted transcutaneously to the implanted stimulator/receiver unit situated within a recess of the temporal bone of the user. This transcutaneous transmission occurs via the external transmitter coil which is positioned to communicate with an implanted receiver coil provided with the stimulator/receiver unit. This communication serves two essential purposes, firstly to transcutaneously transmit the coded sound signal and secondly to provide power to the implanted stimulator/receiver unit. Conventionally, this link has been in the form of an RF link, but other such links have been proposed and implemented with varying degrees of success.

The implanted stimulator/receiver unit traditionally includes a receiver coil that receives the coded signal and power from the external processor component, and a stimulator that processes the coded signal and outputs a stimulation signal to an intracochlea electrode which applies the electrical stimulation directly to the auditory nerve producing a hearing sensation corresponding to the original detected sound. As such, the implanted stimulator/receiver device has been a relatively passive unit that has relied on the reception of both power and data from the external unit to perform its required function.

Traditionally, the external componentry has been carried on the body of the user, such as in a pocket of the user's clothing, a belt pouch or in a harness, while the microphone has been mounted on a clip mounted behind the ear or on the lapel, of the user.

More recently, due in the main to improvements in technology, the physical dimensions of the sound processor have been able to be reduced allowing for the external componentry to be housed in a small unit capable of being worn behind the ear of the user. This unit allows the microphone, power unit and the sound processor to be housed in a single unit capable of being discretely worn behind the ear, with the external transmitter coil still positioned on the side of the user's head to allow for the transmission of the coded sound signal from the sound processor and power to the implanted stimulator unit.

It is envisaged that with further improvements in technology, it will be capable of incorporating all components of the system totally implanted within the head of the user, thereby providing a system that is totally invisible to external visual inspection and capable of operating, at least for a portion of time, independent from any external component

It should be understood however, that whilst the packaging of the device has, and will continue to become smaller and more simplified, the actual system continues to remain a complicated one, consisting of a number of discrete components that cooperate together to produce a desired end result. Therefore as the implant becomes capable of performing more complicated tasks and delivering more complicated stimulation sequences and speech processing strategies, the interfaces and protocols between each of the different system elements is becoming continually more complex, to ensure that the integrity of the data and information being transferred within the system is maintained. This complexity and necessity for accurate control over the signals being transmitted throughout the system has made it very difficult for individuals without such intimate system-level knowledge of the product, to perform research studies that enable the basic parameters of the device to be altered and changed to suit a particular study. Such research studies typically require only high level or basic knowledge of the basic parameters of the device, without need to understand the detailed and complex system requirements, such as the manner in which the speech processor of a cochlear implant processes received audio signals into a coded RF signal.

In the field of cochlear implants, much work has been and will continue to be undertaken in investigating the effects of various stimulation patterns and the resultant sensation received by the implant user to such patterns. In the ongoing search for constantly improving the way in which a detected sound is presented to a cochlear implant recipient so that the resultant hearing sensation resembles as closely as possible that which a naturally hearing person would experience, there is a very real need to provide such researchers with the tools which enable them to perform this investigation more easily. In such instances it is important that the person performing the research is primarily concerned with the area of investigation rather than having to factor into the investigation an intricate understanding of the particular implant being used and the interfaces that exist within the hardware of the implant itself.

As alluded to above, the behaviour of an implanted stimulator is determined by the RF signal that is transmitted to it by the speech processor. In order for a desired stimulation pattern to be delivered to the implantee, the correct RF signal must be transmitted to the implanted stimulator. To ensure correct operation of the output of the stimulator, a researcher has typically required intricate knowledge of the implant, of the RF encoding protocol, of the speech processor and of the hardware interface to which the speech processor is connected.

The present invention provides a means for researchers to control the output of cochlear implants without the necessity to understand the intricacies of the implant's construction and performance.

Embodiments of the present invention may also provide a means for researchers to conduct more complex studies of the effects of various stimulation patterns on speech and sound perception than has been possible with existing research devices.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

### SUMMARY OF THE INVENTION

According to a first aspect, the present invention resides in a software library comprising a plurality of predetermined software modules, each software module defining instructions for control of a tissue-stimulating prosthesis.

According to a second aspect, the present invention resides in a communication means for communicating with a tissue-stimulating prosthesis, the communication means being operable to output a software command set to the prosthesis for causing the prosthesis to generate a stimulation pattern, the communication means including a library of predetermined software modules for use in the creation of the software command set.

The communication means is preferably operable in response to a set of arbitrary commands from a user.

According to a third aspect, the present invention resides in a storage means storing in machine readable digital form a plurality of software modules, each software module defining instructions for control of a tissue-stimulating prosthesis.

According to a fourth aspect, the present invention resides in a cochlear implant communicator operable to present an interface for receiving instructions from a user, and operable to call upon functions within a stored communicator library, wherein said functions are operable to control the implant in accordance with the instructions received from the user, wherein said instructions do not require intricate knowledge of the implant's construction and performance.

According to a fifth aspect, the present invention provides a method for controlling a tissue-stimulating prosthesis, the method comprising the steps of:

receiving user instructions specifying a desired action of the prosthesis; and

accessing a library of predetermined software modules in order to build a software command set for causing the prosthesis to perform the desired action.

According to a sixth aspect, the present invention provides a method for controlling a tissue-stimulating prosthesis, the method comprising the steps of:

receiving arbitrary user instructions specifying a desired action of the prosthesis; and

accessing a library of predetermined software modules in order to allow said arbitrary user instructions to be performed by the prosthesis to perform said desired action.

By providing a communication means which can accept high level instructions or arbitrary instructions from a user and use those instructions to control a tissue-stimulating prosthesis in the desired manner, the present invention allows a user of the communication means to control the prosthesis without the need for the user to have detailed knowledge of system-level requirements of the prosthesis, such as RF cycle timings, current amplitudes, prosthesis powering requirements and the like. Such an arrangement may enable researchers to focus on physiological stimulations and responses with minimal distraction from low level system requirements.

The instructions of each of the software modules may comprise instructions for defining a stimulus pattern to be generated by the prosthesis. Alternatively, the instructions may control acquisition of telemetry by the prosthesis, and/or may relate to communication of data from the prosthesis, such as data indicating system conditions within the prosthesis, or acquired telemetry data.

In a preferred embodiment, the tissue-stimulating prosthesis can be an implantable prosthesis. Still more preferably, the prosthesis can be a cochlear implant. For the purposes of the following description, the tissue-stimulating prosthesis will be described in terms of a cochlear implant having a speech processor. In particular, the device will be described with reference to cochlear implants developed by the present applicant, such as the Nucleus® family of implants. It is to be appreciated that the present invention could have application in all types of cochlear implants and other tissue-stimulating devices other than cochlear implants.

The communication means can comprise or be part of a computing means, such as a personal computer (PC). Such a computer preferably includes a graphical user interface (GUI) that allows a user to provide instructions to the communication means, such as specifying various parameters of the functions or modules stored in the library. The user can preferably use a keyboard, mouse, touchpad, joystick or other known device to operate the computing means and GUI.

The software command set, derived from one or more modules, can be output to the speech processor through a hardware interface (such as a Clinical Programming System (CPS) or a Portable Programming System (PPS)) in order to cause the cochlear implant to output a stimulation pattern to a cochlear implant user. The software command set could also be output directly to the speech processor, and it is also possible that the software command set may also be output directly to the implant without the need to bypass the speech processor should an appropriate connection be utilised. The use of the library of predetermined software commands/modules allows a researcher interested in studying the performance of cochlear implants to create appropriate software command sets without having to fully understand the intricacies of the operation of the components of the cochlear implant, including the interface hardware, the speech processor, the RF interface (between the speech processor and the implant) and the implant hardware. Typically, the knowledge required by a software developer developing the software is generally concerned with an understanding of the capabilities and limits of the hardware functionality, such as the maximum stimulation rate possible with the implant and the like.

The library achieves this abstraction form the hardware by providing a basic interface that preferably uses the notion of a frame as the basis for all other parts of the library. The frame can be a stimulus frame which specifies a single current pulse to be output by the implant or a non-stimulus frame that specifies an implant command, such as a telemetry command. The frame could also specify simultaneous stimulations to be output by the implant. A user of a system in accordance with the present invention, such as a researcher, may specify individually in each frame any or all of the following: the electrode(s) to be stimulated (eg. selecting one or more of 22 intra-cochlear electrodes); the reference electrode (eg. selecting one or more of 22 intra-cochlear electrodes and two extra-cochlear electrodes); the pulse current level; the pulse phase width; the phase gap; and the period of each stimulus frame. Accordingly, a software module set derived from such instructions by use of the software module library will typically comprise one or more frames in accordance with the instructions.

The frame can also be non-stimulus frame which is used to cause some operation by the implant apart from issuing a stimulation pulse.

A particular stimulation pattern can comprise a sequence of desired stimulation frames. A sequence can include the stimulus frames that are to be transmitted to the implant and/or other control logic, including non-stimulus frames. The sequence can be understood as a data container for command tokens, with a command token representing one frame or the required control information. For example, in addition to the command token to transmit a frame to the implant, there can be command tokens to trigger the acquisition of telemetry at the appropriate time in the sequence, command tokens to trigger communication back to the computing means, and so on.

Accordingly, the communication means preferably further comprises a sequence generator. Such a sequence generator can be used to produce a ready made sequence of frames for a specific purpose. An example of such a sequence generator is a psychophysics sequence generator, which takes timing of burst duration, inter-burst gap, number of bursts and the like and produces a corresponding sequence. The use of such a sequence generator has a number of advantages as it does not require knowledge of the individual stimulation frames that would be in such a sequence, rather the user operates simply at the level of the psychophysic parameters mentioned previously. A sequence of frames generated by the sequence generator may be stored for future reference as a further software module in the software library.

A library interface means can be used to allow a user to construct sequence of frames.

When a sequence construction is complete, a sequence image is preferably transmitted and written into the memory of the speech processor of the implant. The sequence image is then processed by a command interpreter present in the speech processor. Each command token is processed by the command interpreter, causing the action associated with the command token to occur. These actions can include transmitting a frame to the implant, acquiring telemetry, or sending a communication to the computing means. The timing of this process is preferably controlled by the command interpreter and is preferably accurate to one RF cycle of the implant/speech processor.

The library of commands/modules can include at least two components, the speech processor software and the computing means software. The speech processor software is preferably the command interpreter that processes the command tokens in the sequence, stimulus frames with the desired stimulation pattern, non-stimulus frames that control the implant in a desired fashion, and/or appropriate control logic all can result as part of this processing. The computing means software can typically be divided into two modules, that which constructs the sequence and that which deals with the communications between the speech processor and the computing means.

The software library preferably includes one or more implant classes. The implant classes present in the library preferably model the various types of cochlear implants that be interfaced with the communication means, for example the Nucleus® 22 and Nucleus® 24 cochlear implants. The implant class model preferably includes all relevant implant characteristics so as to ensure appropriate interaction between the output of the communication means and the implant that is interfaced thereto at any particular time. Implant characteristics such as transmit frequency, the RF protocol, the minimum and maximum current levels can all be included in the model. On interfacing an implant to the communication means, the first task preferably performed by the communication means is to use the library to create an object of the appropriate implant type. In one embodiment, the library can internally maintain a number of implant objects, containing all necessary parameters. At least one of the objects must be selected before the communication means can commence interfacing with the implant. In another embodiment, the library interface means can be used to create and then manage an implant object to be used by the communication means.

The library can be written in a programming language such as C or C++. The library can be a dynamic link library (DILL). Applications by the user can be written using any programming development environment that can call the functions of an external library, for example, Borland Delphi, Microsoft Visual C++, or Borland C++ Builder.

In a further embodiment, a stimulus pulse is defined by the channel number (eg. 1-22) and its magnitude (eg. 0-1023). This format can be used internally in the speech processor of the implant as an input to the mapping function. The mapping function maps the input to patient specific parameters such as active electrode, reference electrode, current level, phase width using the implantee's threshold and comfort levels. This embodiment has a number of advantages, as follows:

it allows subject-independent stimulus data to be stored

processing does not have to be repeated for each subject

mapping varies for each subject

it reduces the amount of data to be stored or transmitted

it reduces the risk of over-stimulation

it allows a global volume control on all stimuli in a sequence.

In a further embodiment, it can be envisaged that individual stimulation frames can be sent directly from the computing means to the implant. This is in contrast to the situation, as described above, where the user must download a sequence into the memory of the speech processor. This embodiment allows for processing of a sound recording (into equivalent stimulation frames) to be performed “offline” and then in real time the stimulation frames would be sent to the implant. This streaming mode allows much longer stimulation patterns to be delivered to the implantee than can be typically stored in the memory of a speech processor. The “offline” processing could be performed in an application such as MATLAB.

As discussed, the communication means could output non-stimulus frames that result in the implant returning telemetry to the communication means from the implant. For example, impedance telemetry (ie. the impedance between two electrodes of a channel can be calculated by measuring the voltage on the electrodes during the stimulation phase), compliance telemetry (ie. a measurement that confirms that the implant is delivering the specified amount of current to a channel) and neural response telemetry (ie. a measurement of the response of the nerves to a stimulus pulse) can be performed. In a preferred embodiment, the non-stimulus frames can be embedded within a sequence of stimulation frames. Such non-stimulus frames may, for example, result in the following sequence of commands being provided to the speech processor:

(i) start a new buffer;

(ii) store results in the buffer;

(iii) average x number of stored results; and

(iv) transmit average results back to the computing means.

In a still further embodiment, the communication means can output a trigger signal used to trigger the operation of equipment external to the communication means. For example, a trigger may be output in order to start recording of evoked potentials with suitable equipment, such as an EABR (Electrically Elicited Auditory Brainstem) machine, or for testing purposes with the stimulation frames of interest being captured with a digital storage oscilloscope (DSO) or similar.

The library of commands/modules preferably includes a trigger enabling command and a trigger disabling command. The trigger enable and trigger disable commands are placed appropriately to produce the desired output, for example, appended to a sequence after the desired frame for which a trigger is to be generated. This ensures there is a delay between the frame command being processed and the stimulus being presented to the implantee.

The present invention further provides a method of testing the performance of a tissue-stimulating prosthesis, such as an implantable prosthesis. The prosthesis can in turn be a cochlear implant.

The present invention also provides a method of communicating with a cochlear implant using a communication means as described herein.

The present invention provides a number of advantages to researchers working in the field of cochlear implants. Its use does not require the researcher to understand the exact workings of the hardware of the implant to ensure appropriate stimulation patterns are output by the implant. It also allows researchers to more rapidly implement new ideas and experiments with implants and ascertain the results than is achievable using traditional techniques.

The potential applications include acute animal experiments, psychophysical experiments, evoked potential research and speech coding research.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

By way of example only, a preferred mode of carrying out the invention is described with reference to the accompanying drawings:

FIG. 1 is one example of the NIC library architecture according to the present invention;

FIG. 2 is a stimulus frame with parameters;

FIG. 3 is an example of the implant and frame class hierarchy;

FIG. 4 is timing for sync example; and

FIG. 5 is a pictorial representation of a prior art cochlear implant system.

### PREFERRED MODE OF CARRYING OUT THE INVENTION

Before describing the features of the present invention, it is appropriate to briefly describe the construction of one type of known cochlear implant system with reference to FIG. 5.

Known cochlear implants typically consist of two main components, an external component including a sound (speech) processor 29, and an internal component including an implanted receiver and stimulator unit 22. The external component includes an on-board microphone 27. The speech processor 29 is, in this illustration, constructed and arranged so that it can fit behind the outer ear 11. Alternative versions may be worn on the body. Attached to the speech processor 29 is a transmitter coil 24 which transmits electrical signals to the implanted unit 22 via an RF link.

The implanted component includes a receiver coil 23 for receiving power and data from the transmitter coil 24. A cable 21 extends from the implanted receiver and stimulator unit 22 to the cochlea 12 and terminates in an electrode array 20. The signals thus received are applied by the array 20 to the basilar membrane 8 thereby stimulating the auditory nerve 9. The operation of such a device is described, for example, in U.S. Pat. No. 4,532,930.

The sound processor 29 of the cochlear implant can perform an audio spectral analysis of the acoustic signals and outputs channel amplitude levels. The sound processor 29 can also sort the outputs in order of magnitude or flag the spectral maxima as used in the SPEAK™ strategy developed by Cochlear Ltd.

For the purposes of the following description “NIC” stands for “Nucleus® Implant Communicator”. While the following description is directed to a description of a system for use with implants developed by the present applicant, it will be appreciated that the present invention has application to other implants and devices which employ the same or similar operating principles.

Overview

As described above, the behaviour of a cochlear implant is determined by the RF signal that is transmitted to it by the speech processor. In order for a desired stimulation pattern to be delivered to the implant recipient, the correct RF signal must be transmitted to the implant. To operate at this low level of abstraction requires intricate knowledge of the implant, of the RF encoding protocol, of the speech processor and of the hardware interface (to which the speech processor is connected). The library of software commands according to the present invention (hereinafter the “NIC Library”) aims to avoid this by providing a high level interface to the Nucleus cochlear implant system.

The NIC Library uses a frame as the basis for all other parts of the library. A stimulus frame specifies a single current pulse, while a non-stimulus frame specifies an implant command, such as a telemetry command. Non-stimulus frames are typically handled automatically by the library to achieve the desired results. A sequence represents the frames that are to be transmitted to the implant and other control logic; it is constructed by the NIC application (sequence generator). The sequence is actually a data container for command tokens, with a command token representing one frame or the required control information. (For example, in addition to the command token to transmit a frame to the implant, there are command tokens to trigger the acquisition of telemetry at the appropriate time in the sequence, command tokens to trigger communication back to the PC, and so on.) When the sequence construction is complete, the sequence image is written to the speech processor memory. The sequence image is then processed by the NIC command interpreter, present in the speech processor (eg. Cochlear Sprint™ processor). Each command token is processed by the command interpreter, causing the action associated with the command token to occur. As already discussed, these actions include transmitting a frame to the implant, acquiring telemetry from the implant, or sending a communication message to the PC. All timing is controlled by the command interpreter and is accurate to one RF cycle of the implant/speech processor.

Architecture

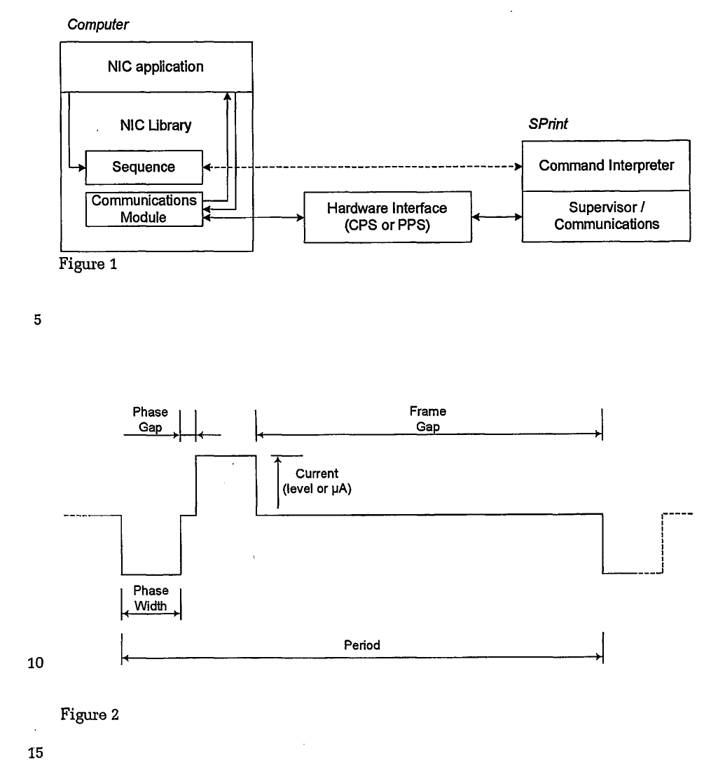

The NIC Library consists of two components, the speech processor software and the PC software; see FIG. 1. As discussed above, the speech processor software is a command interpreter that processes the command tokens in the sequence; stimulus frames with the desired stimulation pattern, non-stimulus frames that control the implant in a desired fashion, or appropriate control logic all result as part of this processing. The PC software meanwhile can be loosely divided into two modules, that which constructs the sequence and that which deals with the communications between the speech processor and the PC.

NIC Library Interface

In a preferred embodiment, the NIC Library provides a C language interface that the NIC application (ie. an application program that uses the NIC software library) can use, which is at the level of clinically meaningful units as detailed in Table 1; this is also illustrated in FIG. 2 for a stimulus frame (ie. a frame that produces one biphasic current pulse with “frame” being the basic unit of information that is transmitted from the speech processor to an implant). Note that if the current is specified in microamps, then it is possible to describe a stimulus in a manner that is completely independent of the implant model and protocol. However, clinicians are accustomed to thinking in terms of current level, which is implant dependent.

TABLE 1
Method of Specifying Stimulation Parameters

| Parameter | Specifiable Values |
|---|---|
| Stimulation electrodes | 1-22, ECE1 and ECE2 |
| Stimulation modes | CG, BP, BP + 1, MP1, |
| | MP1 + 2, etc. |
| Currents | as a current level or in |
| | microAmps (μA) |
| Timing parameters | in microseconds (μs) |
| (includes phase width, phase gap, etc.) | |

Implant and Frame Classes

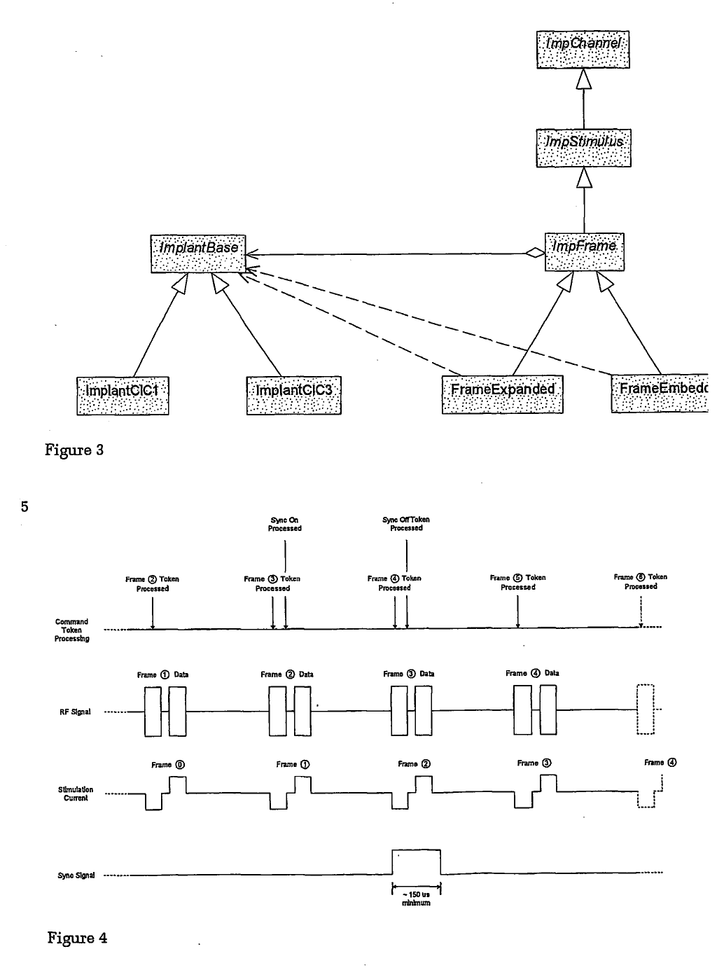

Implant and frame classes, in conjunction with sequence classes, provide the basis for the NIC Library. The implant classes model the various implant types that exist; a class exists for the CIC1 series implants (ie. the integrated circuit used in first generation Nucleus cochlear implants) and a class exists for the CIC3 series implants (ie. the integrated circuit used in present-generation Nucleus cochlear implants). The implant characteristics of transmission frequency, the RF protocol, the minimum and maximum current level, and so on are all included in the models and so are not required to be known by the researcher. In a similar fashion, the frame classes model the way in which parameters specified at the clinical interface level are translated into parameters which can be dealt with by the implant. This includes RF protocol encoding and so forth. Both the implant class hierarchy and the frame class hierarchy are closely interrelated; the relationship between the two hierarchies is illustrated in FIG. 3.

It should be noted, that as far as the NIC application is concerned, this hierarchy is internal to the NIC Library. The NIC application and the NIC user need only be concerned with the C language interface provided, and expect that the NIC Library will correctly manage the internal parts.

Creating Implant Objects

Much of how the NIC Library behaves depends upon which implant type is to be used; as one example, the minimum and maximum current is dependent upon whether a CIC1 series implant or a CIC3 series implant is used. For this reason, the first task that an NIC application must perform in order to use NIC Library is to create an object of the appropriate implant type. The implant object is then used wherever needed to create instantiations of the frame classes, the sequence classes and so on.

Two methods exist with which to create implant objects. The first method uses the fact that the NIC Library internally maintains a number of implant objects, with all possibility of parameters. These will automatically be used by the creation functions which are ImpFrameNew for the frame objects, ImpSequenceNew for the sequence objects and ImpedanceTestNew for the impedance test objects. An implant object must be selected before one of these functions is invoked. This first method is illustrated in Listing 1.

Listing 1 - Selecting Implant Objects

```
/* In the application code. */
...
/* Select an implant object for a CIC1 series implant. This will use
an RF frequency
* of 2.5 MHz and the expanded RF protocol. Ensure that the function
succeeded. */
int errorCode = ImplantSelectType(CIC1, EXPANDED, 2.5);
if (errorCode != 0)
{
    fprintf(stderr, “The function ImplantSelectType(CIC1, EXPANDED,
2.5) failed\n”);
    return;
}
/* Create an implant object for a CIC3 series implant. This will use
an RF frequency
* of 5.0 MHz and the embedded RF protocol. Ensure that the function
succeeded. */
errorCode = ImplantSelectType(CIC3, EMBEDDED, 5.0);
if (errorCode != 0)
{
    fprintf(stderr, “The function ImplantSelectType(CIC3, EMBEDDED,
5.0) failed\n”);
    return;
}
/* Further application processing as necessary. */
...
```

The second method is for the NIC application to create and then manage the implant objects that it wants to use. This method is totally separate from the first method previously mentioned. The implant objects, created with this method, can then be used with separate creation functions for the frame, sequence and impedance test objects; these are ImpFrameNewWithImplant for the frame objects, ImpSequenceNewWithImplant for the sequence objects and ImpedanceTestNewWithImplant for the impedance test objects. Note that it is very important for the destroy function to be called on any of the implant objects created with this method, as memory management is the NIC application's responsibility.

Listing 2 - Creating Implant Objects

```
/* In the application code. */
...
/* Create an implant object for a CIC1 series implant. This will use
an RF frequency
* of 2.5 MHz and the expanded RF protocol. Ensure that the function
succeeded. */
IMPLANT* cic1_implant = ImplantNew(2.5, EXPANDED);
if (!cic1_implant)
{
    fprintf(stderr, “The function ImplantNew(2.5, EXPANDED)
failed\n”);
    return;
}
/* Create an implant object for a CIC3 series implant. This will use
an RF frequency
* of 5.0 MHz and the embedded RF protocol. Ensure that the function
succeeded. */
IMPLANT* cic3_implant = ImplantNew(5.0, EMBEDDED);
if (!cic3_implant)
{
    fprintf(stderr, “The function ImplantNew(5.0, EMBEDDED)
failed\n”);
    return;
}
/* Further application processing as necessary. */
...
/* Now destroy the implant objects to reclaim the memory; they are no
longer needed. */
ImplantDelete(cic1_implant);
ImplantDelete(cic3_implant);
```

Creating Frame Objects

To create a frame object, the appropriate creation function ImpFrameNew or ImpFrameNewWithImplant must be invoked. The frame object will be created appropriately for the implant object either selected, in the case of the function ImpFrameNew, or provided as the function parameter, in the case of the function ImpFrameNewWithImplant. Listing 3 illustrates this process with an example for both methods of frame object creation.

Listing 3 - Creating Frame Objects

```
/* In the application code. */
...
/* Select a CIC3 series implant. */
int errorCode = ImplantSelectType(CIC3, EMBEDDED, 5.0);
if (errorCode != 0)
{
    fprintf(stderr, “The function ImplantSelectType(CIC3, EMBEDDED,
5.0) failed\n”);
    return;
}
/* Now use the selected implant to create an appropriate frame object.
*/
IMP_FRAME* frame1 = ImpFrameNew( );
if (!frame1)
{
    fprintf(stderr, “The function ImpFrameNew( ) failed\n”);
    return;
}
/* Further application processing as necessary. */
...
/* Now create a frame object directly from an implant object. */
/* First create the implant object. */
IMPLANT* cic3_implant = ImplantNew(5.0, EMBEDDED);
if (!cic3_implant)
{
    fprintf(stderr, “The function ImplantNew(5.0, EMBEDDED)
failed\n”);
    return;
}
/* And now create the frame object. */
IMP_FRAME* frame2 = ImpFrameNewWithImplant(cic3_implant);
if (!frame2)
{
    fprintf(stderr, “The function
ImpFrameNewWithImplant(cic3_implant) failed\n”);
    return;
}
/* Further application processing as necessary. */
...
/* And don't forget to delete the objects! */
ImpFrameDelete(frame1);
ImpFrameDelete(frame2);
ImplantDelete(cic3_implant);
```

Setting Frame Parameters

Functions are provided to set the parameters of frame objects, and these are detailed in Table 2. An example of setting these parameters, with typically values, is provided in Listing 4.

TABLE 2
ImpStimulus Interface

| Parameter | Frame Function |
|---|---|
| Active electrode, | ImpFrameGetActiveElectrode, |
| Reference electrode | ImpFrameGetReferenceElectrode/ |
| | ImpFrameSetElectrodes |
| Current level | ImpFrameGetcurrentLevel/ |
| | ImpFrameSetCurrentLevel |
| Current | ImpFrameGetCurrent/ImpFrameSetCurrent |
| phase width | ImpFrameGetPhaseWidth/ImpFrameSetPhaseWidth |
| phase gap | ImpFrameGetPhaseGap/ImpFrameSetPhaseGap |
| Period | ImpFrameGetPeriod/ImpFrameSetPeriod |

Listing 4 - Frame Parameter Setting Example

```
/* Select a CIC3 series implant. */
int errorCode = ImplantSelectType(CIC3, EMBEDDED, 5.0);
if (errorCode != 0)
{
    fprintf(stderr, “The function ImplantSelectType(CIC3, EMBEDDED,
5.0) failed\n”);
    return;
}
/* Now use the selected implant to create an appropriate frame object.
*/
IMP_FRAME* frame = ImpFrameNew( );
if (!frame)
{
    fprintf(stderr, “The function ImpFrameNew( ) failed\n”);
    return;
}
/* Set the electrode parameters; MP1+2 stimulation on electrode 10. */
errorCode = ImpFrameSetElectrodes(frame, 10, ECE1_2);
if (errorCode != 0)
{
    fprintf(stderr, “The function ImpFrameSetElectrodes(frame, 10,
ECE1_2) failed\n”);
    ImpFrameDelete(frame);
    return;
}
/* Set the current level parameter; a level of 180. */
errorCode = ImpFrameSetCurrentLevel(frame, 180);
if (errorCode != 0)
{
    fprintf(stderr, “The function ImpFrameSetCurrentLevel(frame,
180) failed\n”);
    ImpFrameDelete(frame);
    return;
}
/* Set the phase width parameter; a duration of 50.0 us. */
errorCode = ImpFrameSetPhaseWidth(frame, 50.0);
if (errorCode != 0)
{
    fprintf(stderr, “The function ImpFrameSetPhaseWidth(frame, 50.0)
failed\n”);
    ImpFrameDelete(frame);
    return;
}
/* Set the phase gap parameter; a duration of 20.0 us. */
errorCode = ImpFrameSetPhaseGap(frame, 20.0);
if (errorCode != 0)
{
    fprintf(stderr, “The function ImpFrameSetPhaseGap(frame, 20.0)
failed\n”);
    ImpFrameDelete(frame);
    return;
}
/* Set the period parameter; a period is 4000.0 us, or a stimulation
rate of 250 Hz. */
errorCode = ImpFrameSetPeriod(frame, 4000.0);
if (errorCode != 0)
{
    fprintf(stderr, “The function ImpFrameSetPeriod(frame, 4000.0)
failed\n”);
    ImpFrameDelete(frame);
    return;
}
/* Use the newly created frame as and when needed. */
...
/* And don't forget to delete all objects created. */
ImpFrameDelete(frame);
```

Timing Parameters in the Frame Classes

Two issues exist with regard to timing parameters for the frame classes. The first issue is that the minimum resolution of the timing parameters is dependent upon the protocol used and the resolution of the internal speech processor registers. The second issue is that the timing parameters are related to each other, and also to internal protocol specific elements. Both these issues, and how the NIC Library deals with them, are discussed in this section.

The first issue is the accuracy of the system timing. The system timing accuracy is to within the limits of one RF cycle of the implant/speech processor. With regard to implant, for the CICI series implants, this is one cycle of its 2.5 MHz (400 ns) RF signal, while for the CIC3 series implants, this is one cycle of its 5.0 MHz (200 ns) signal. With regard to the speech processor, this depends upon the internal representation of the timing parameters, which changes to accommodate the size of the timing parameter. To deal with this resolution issue, for both the implant and speech processor, the NIC Library accurately models each component and will automatically modify the timing parameters to the closest possible value. It is important to take into consideration that the timing parameters will be adjusted in the direction of maximum “safety”; the phase width parameter will be reduced to the closest value, while both the phase gap and period parameters will be increased to the closest value.

An example of this accommodation of the possible timing values is presented in Table 3. This is for a CIC3 series implant (which uses a 5.0 MHz RF frequency) and the SPrint speech processor.

TABLE 3
Timing Quantization Example

| Timing Parameter | Value Specified | Value Used |
|---|---|---|
| phase width | 100.0 μs | 99.8 μs |
| phase gap | 28.1 μs | 28.2 μs |
| period | 4655 μs | 4655.2 μs |

The second issue is the inter-relationships that exist between the timing parameters. The main concept here is that the period must be larger than the combination of twice the phase width plus the phase gap. This is further complicated, however, by the specifics of the protocols themselves. For this reason, the approach was taken for the NIC Library whereby the phase width and phase gap parameters have priority over the period parameter. When setting the timing parameters of a frame object this needs to be taken into consideration.

In practice, this means that if the phase width and phase gap parameter values are such that the period parameter value would not be large enough to accommodate them, then the period parameter value will be increased as necessary. This issue is best illustrated with an example, provided in Listing 5. A frame object is to be created for a CIC3 implant The phase width is to be set to 100 μs, the phase gap to 50 μs and the period to 200 μs (i.e. a stimulation rate of 5 kHz). Obviously, the period value is too short in duration to accommodate two phase widths, with a duration of 100 μs each, and the phase gap, with a duration of 50 μs. The period value will be increased automatically to a value of approximately 260 μs (the exact value depends on the embedded RF protocol (ie. a protocol that encodes the frame parameters as binary amplitude modulation of the RF bursts for each phase).

Listing 5 - Frame Timing Parameter Example

```
/* A CIC3 series implant has been selected, a frame has been created
and its electrodes
* and current level have been set. These steps are not relevant to
the example. */
...
/* Set the phase width parameter; a duration of 100.0 us. */
errorCode = ImpFrameSetPhaseWidth(frame, 100.0);
if (errorCode != 0)
{
    fprintf(stderr, “The function ImpFrameSetPhaseWidth(frame,
100.0) failed\n”);
    ImpFrameDelete(frame);
    return;
}
/* Set the phase gap parameter; a duration of 50.0 us. */
errorCode = ImpFrameSetPhaseGap(frame, 50.0);
if (errorCode != 0)
{
    fprintf(stderr, “The function ImpFrameSetPhaseGap(frame, 50.0)
failed\n”);
    ImpFrameDelete(frame);
    return;
}
/* Set the period parameter; a period is 200.0 us. */
errorCode = ImpFrameSetPeriod(frame, 200.0);
if (errorCode != 0)
{
    fprintf(stderr, “The function ImpFrameSetPeriod(frame, 200.0)
failed\n”);
    ImpFrameDelete(frame);
    return;
}
/* Now get the period parameter. It will not be 200.0 us as set
above, rather it will
* be approximately 260 us, because of the priority of the phase width
and phase gap
* parameters over the period parameter. */
Microsec new_period = ImpFrameGetPeriod(frame);
if (new_period < 0)
{
    fprintf(stderr, “The function ImpFrameGetPeriod(frame)
failed\n”);
    ImpFrameDelete(frame);
    return;
}
/* Remainder of NIC application code. */
...
```

Sequences

As already discussed, a sequence is a container for command tokens. Each command token has an action associated with it, which is performed by the command interpreter at the time the command token is processed. Some examples of the command tokens that exist in the AIC Library, and their functionality, are detailed in Table 4.

| Command Token | Functionality |
|---|---|
| Channel Magnitude | Instructs the command interpreter to transmit a |
| | frame to the implant. Only channel and magnitude |
| | are specified in the token, with the remaining |
| | information supplied by the built-in mapping |
| | functionality. This token uses less memory than the |
| | frame token. |
| End | Indicates to the command interpreter that |
| | processing of the sequence should cease. No further |
| | tokens will be processed and power frames will be |
| | transmitted to keep the implant powered if required. |
| Frame | Instructs the command interpreter to transmits a |
| | frame to the implant. |
| Next | The end of a repeat loop. See the repeat command |
| | token for more details. |
| Pause | Instructs the command interpreter to pause in |
| | processing tokens. No frames are transmitted to the |
| | implant during this time. |
| Power Frame | Instructs the command interpreter to transmit a |
| | power frame to the implant. |
| Power Frame | Configures the command interpreter with the frame |
| Configuration | to be used in situations where a power frame is |
| | required. |
| Protocol | Configuration token that specifies the RF protocol |
| | and related information. |
| | This token is inserted automatically by the library, |
| | where required. |
| Repeat | The start of a repeat loop. All command tokens |
| | between this and the corresponding next command |
| | token will be repeated. The number of times that |
| | the loop is repeated is included as part of this |
| | command token. |
| Restart | Indicates to the command interpreter that |
| | processing of the sequence should begin again from |
| | the beginning of the sequence. This process will |
| | continue indefinitely, and no further tokens in the |
| | sequence are processed beyond this token. |
| Retrieve Telemetry | The command interpreter retrieves the location of |
| Pointers | the telemetry pointers from memory, which had |
| | been stored with the store telemetry pointers |
| | command token. |
| Send | Instructs the command interpreter to send a |
| Communications | communications message from the speech processor |
| Message | to the PC. |
| Store Telemetry | The command interpreter remembers the current |
| Pointers | location of the telemetry pointers. |
| Telemetry | Instructs the command interpreter to collect |
| | telemetry samples. |
| Version | Identifies the version of the command interpreter. |
| | This token is inserted automatically by the library, |
| | where required. |

Table 4—Command Tokens

It is preferred that the NIC application never actually deals with the command tokens directly, rather an interface is provided to manage any dealings with sequence objects. For example, an NIC application can never directly add a frame command token to a sequence object, rather it invokes the function ImpSequenceAppendFrame or ImpSequenceAppendFrames to perform this task. So for many of the tokens, there is a one-to-one mapping between the command token and a function provided in the sequence interface. However, some of the command tokens detailed above may never be dealt with, even through an appropriate sequence interface function. Rather the sequence classes will insert the token automatically as needed and in the correct location.

Creating Sequence Objects

The creation of sequence objects is much very similar to the creation of frame objects. Two functions are provided in the sequence interface to create sequence objects, ImpSequenceNew and ImpSequenceNewWithImplant. For the first function, a sequence object will be created appropriately for the implant object selected previously, or in the case of the second function, the implant object provided as the function parameter will be used. Listing illustrates an example of both of these methods of sequence object creation.

Listing 6 - Sequence Object Creation

```
/* In the application code. */
...
/* Select a CIC3 series implant. */
int errorCode = ImplantSelectType(CIC3, EMBEDDED, 4.2);
if (errorCode != 0)
{
    fprintf(stderr, “The function ImplantSelectType(CIC3, EMBEDDED,
4.2) failed\n”);
    return;
}
/* Now use the selected implant to create an appropriate sequence
object. */
IMP_SEQUENCE* sequence1 = ImpSequenceNew( );
if (!sequence1)
{
    /* The function ImpSequenceNew failed. Inform the user. */
    fprintf(stderr, “The function ImpSequenceNew( ) failed\n”);
    ...
}
/* Further application processing as required, using the sequence
object. */
...
/* Now create a sequence object directly from an implant object. */
/* First create the implant object. */
IMPLANT* cic3_implant = ImplantNew(4.2, EMBEDDED);
if (!cic3_implant)
{
    /* The function ImplantNew failed. Inform the user. */
    fprintf(stderr, “The function ImplantNew(4.2, EMBEDDED)
failed\n”);
...
}
/* And now create the sequence object. */
IMP_SEQUENCE* sequence2 =
ImpSequenceNewWithImplant(cic3_implant);
if (!sequence2)
{
    /* The function ImpSequenceNewWithImplant failed. Inform the
    user. */
    fprintf(stderr, “The function ImpSequenceNewWithImplant( )
failed\n”);
...
}
/* Further application processing as necessary. */
...
/* And don't forget to delete the objects! */
ImpSequenceDelete(sequence1);
ImpSequenceDelete(sequence2);
ImplantDelete(cic3_implant);
/* Remainder of NIC application code. */
...
```

Storing Sequence Objects

The present embodiment provides two functions in the sequence interface to manage the storage and retrieval of sequence objects; these are ImpSequenceReadSequence and ImpSequenceWriteSequence. These functions can be used to store a series of stimulation sequences to disk and use them as appropriate at a later time.

Listing 7 illustrates the use of these functions.

Listing 7 - Sequence Storage/Retrieval Example

```
/* In the application code. A sequence object has been created
previously. */
...
/* Store the sequence, previously constructed, to the file
example1.seq. */
error_code = ImpSequenceWriteFile(sequence, “example1.seq”);
if (error_code != 0)
{
    /* The function ImpSequenceWriteFile failed. Inform the user.
*/
    fprintf(stderr, “The function ImpSequenceWriteFile( ) failed\n”);
...
}
/* Further application code as required. */
...
/* Retrieve the sequence from the file example1.seq. */
error_code = ImpSequenceReadFile(sequence, “example1.seq”);
if (error_code != 0)
{
    /* The function ImpSequenceReadFile failed. Inform the user. */
    fprintf(stderr, “The function ImpSequenceReadFile( ) failed\n”);
...
}
/* The object sequence now contains
/* Remainder of NIC application code. */
...
```

Adding Command Tokens to a Sequence

Preferably, the sequence interface provides a number of functions which append command tokens (as detailed in Table 4) directly to the sequence object. In particular, these functions include appending frame objects to the sequence object, which will be dealt with in this section, and loop command tokens. The functions ImpSequenceAppendFrame and ImpSequenceAppendPowerFrame will cause a frame to be transmitted to the implant. The former function takes a frame object as a parameter, while the later function uses the power frame object set up at the time the sequence object was created. Listing 8 8 illustrates the use of these functions.

Listing 8 - Appending Frame Command Tokens

```
/* In the application code. A number of frame and sequence objects
have been created
* previously. */
...
/* Append a frame to the sequence. */
error_code = ImpSequenceAppendFrame(sequence, frame);
if (error_code != 0)
{
/* The function ImpSequenceAppendFrame failed. Notify the user.
*/
    fprintf(stderr, “The function ImpSequenceAppendFrame( )
failed\n”);
    ...
}
/* Append a power frame to the sequence. */
error_code = ImpSequenceAppendPowerFrame(sequence);
if (error_code != 0)
{
    /* The function ImpSequenceAppendPowerFrame failed. Notify the
user. */
    fprintf(stderr, “The function ImpSequenceAppendPowerFrame( )
failed\n”);
    ...
}
/* Perform further sequence construction as required. */
...
/* Signify the end of the sequence with an end token. */
error_code = ImpSequenceAppendEndToken(sequence);
if (error_code != 0)
{
    /* The function ImpSequenceAppendEndToken failed. Notify the
user. */
    fprintf(stderr, “The function ImpSequenceAppendEndToken( )
failed\n”);
    ...
}
```

Loops in Sequences

In the preferred embodiment, the concept of a sequence also includes loops, whereby a set of command tokens can be repeated a specified number of times. This functionality is used automatically in a number of situations to conserve memory in the resultant sequence image (ie. the data structure that defines a sequence). The NIC application does not need to concern itself with the case of automatic use of the looping functionality, other than to realise that some methods using a sequence object will result in a smaller sequence image. This functionality is used automatically for the functions ImpSequenceAppendFrames, ImpSequenceAppendPowerFrames and ImpSequenceAppendSequence (if necessary). Listing 9 9 illustrates when the looping functionality will automatically be used by the sequence object and alternate code to prevent the use of looping functionality.

Listing 9 - Inherent Loop Functionality

```
/* In the application code. A number of frame and sequence objects
have been created
* previously. */
...
/* A loop will be used here automatically to conserve memory. The
loop will repeat one
* hundred (100) times. */
error_code = ImpSequenceAppendFrames(sequence, frame,
100); if (error_code != 0)
{
    /* The function ImpSequenceAppendFrames failed. Notify the
user. */
    fprintf(stderr, “The function ImpSequenceAppendFrames( )
failed\n”);
    ...
}
/* A loop will also be used here automatically. Again the loop will
repeat one
* hundred (100) times. */
error_code = ImpSequenceAppendPowerFrames(sequence,
100); if (error_code != 0)
{
    /* The function ImpSequenceAppendPowerFrames failed. Notify the
user. */
    fprintf(stderr, “The function ImpSequenceAppendPowerFrames( )
failed\n”);
    ...
}
/* And a loop will also be used here automatically. Again the loop
will repeat one
* hundred (100) times. */
error_code = ImpSequenceAppendSequence(sequence, sub_sequence,
100); if (error_code != 0)
{
    /* The function ImpSequenceAppendSequence failed. Notify the
user. */
    fprintf(stderr, “The function ImpSequenceAppendSequence( )
failed\n”);
    ...
}
/* The following code will prevent a loop being used and will transmit
exactly the
* same set of frames to the implant as the first example above.
However, it will use
* far more memory. */
for (int i = 0; i < 100; i++)
{
    error_code = ImpSequenceAppendFrame(sequence, frame);
    if (error_code != 0)
    {
        /* The function ImpSequenceAppendFrame failed. Notify the
user. */
        fprintf(stderr, “The function ImpSequenceAppendFrame( )
failed\n”);
    ...
}
}
/* Perform further sequence construction as required. */
...
/* Signify the end of the sequence with an end token. */
error_code = ImpSequenceAppendEndToken(sequence);
if (error_code != 0)
{
    /* The function ImpSequenceAppendEndToken failed. Notify the
user. */
    fprintf(stderr, “The function ImpSequenceAppendEndToken( )
failed\n”);
    ...
}
```

In addition, the loop structure can be specified manually through appropriate use of the sequence interface functionals ImpSequenceAppendRepeatToken and ImpSequenceAppendNextToken. Listing 10 10 illustrates the use these functions.

Listing 10 - Loop Construction

```
/* In the application code. A number of frame and sequence objects
have been created
* previously. */
...
/* Create a loop that will repeat a two frame sub-sequence, one
hundred
* (100) times. */
error_code = ImpSequenceAppendRepeatToken(sequence, 100);
if (error_code != 0)
{
    /* The function ImpSequenceAppendRepeatToken failed. Notify the
user. */
    fprintf(stderr, “The function ImpSequenceAppendRepeatToken( )
failed\n”);
    ...
}
error_code = ImpSequenceAppendFrame(sequence, frame1);
if (error_code != 0)
{
    /* The function ImpSequenceAppendFrame failed. Notify the user.
*/
    fprintf(stderr, “The function ImpSequenceAppendFrame(frame1)
failed\n”);
    ...
}
error_code = ImpSequenceAppendFrame(sequence, frame2);
if (error_code != 0)
{
    /* The function ImpSequenceAppendFrame failed. Notify the user.
*/
    fprintf(stderr, “The function ImpSequenceAppendFrame(frame2)
failed\n”);
    ...
}
error_code = ImpSequenceAppendNextToken(sequence);
if (error_code != 0)
{
    /* The function ImpSequenceAppendNextToken failed. Notify the
user. */
    fprintf(stderr, “The function ImpSequenceAppendNextToken( )
failed\n”);
    ...
}
/* Perform further sequence construction as required. */
...
/* Signify the end of the sequence with an end token. */
error_code = ImpSequenceAppendEndToken(sequence);
if (error_code != 0)
{
    /* The function ImpSequenceAppendEndToken failed. Notify the
user. */
    fprintf(stderr, “The function ImpSequenceAppendEndToken( )
failed\n”);
    ...
}
```

It should be noted that a smaller sequence image can result in a larger stimulation pattern (due to the conservation of a limited memory space), and. will result in a shorter time to write the sequence image to the speech processor memory.

The sequence interface also has the functionality to repeat a sequence forever. This would be useful when a constant stimulation pattern is required and duration of stimulation is not critical. Listing 11 illustrates an example of the construction of such a sequence.

Listing 11 - Repeat Forever Example

```
/* In the application code. A number of frame and sequence objects
have been created
* previously. */
...
/* Create a sequence that will be repeated “forever” (or at least
until the sequence
* processing is stopped. */
error_code = ImpSequenceAppendFrame(sequence, frame1);
if (error_code != 0)
{
    /* The function ImpSequenceAppendFrame failed. Notify the user.
*/
    fprintf(stderr, “The function ImpSequenceAppendFrame(frame1)
failed\n”);
    ...
}
error_code = ImpSequenceAppendFrame(sequence, frame2);
    if (error_code != 0)
{
/* The function ImpSequenceAppendFrame failed. Notify the user.
*/
fprintf(stderr, “The function ImpSequenceAppendFrame(frame2)
failed\n”);
    ...
}
/* Append other command tokens as required. */
...
/* The sequence is to repeat forever, the repeat forever token is used
in the place of an end token. */
error_code = ImpSequenceRepeatForever(sequence);
if (error_code != 0)
{
    /* The function ImpSequenceRepeatForever failed. Notify the
user. */
    fprintf(stderr, “The function ImpSequenceRepeatForever()
failed\n”);
    ...
}
```

Sequence Generators—Impedance Test

For many sequences that an NIC application may generate, the structure of the sequences will be similar with the exception of some general parameters. Typically these general parameters are of a high level nature; the parameters effect the individual frames in the sequences, however, they have a holistic effect on the sequence. Sequences designed to provide psychophysical stimulation patterns are typical of this effect, there are definite differences in the individual frames within the sequence, though these are caused by differences in the electrodes which are stimulated, the stimulation burst duration, the inter-burst duration, the number of repetitions, etc.

The sequence generator concept allows an NIC application to operate at a higher level of abstraction than individual frames. High level parameters are specified as part of the interface to the sequence generator, and the knowledge of how to generate the appropriate sequence from these parameters is contained internally.

The impedance test sequence generator creates a sequence which invokes the voltage telemetry functionality of the CIC3 implant, and then calculates the impedances present on each electrode specified. An NIC application can use the impedance test sequence generator in order to provide impedance measurement functionality in it. The NIC application can either specify the parameters that are required by the impedance test object or use the sensible defaults that are provided. It is not necessary to have knowledge of the voltage telemetry functionality of the CIC3 implant, in order to use the impedance test sequence generator; indeed it illustrates perfectly the sequence generator concept of an interface level above that of specifying individual frames.

The parameters that can be set through the interface of the ImpedanceTest class, and their defaults, are detailed in Table 5. Each of these parameters is specified through an appropriate set function, eg. for the stimulation mode parameter, the function exists ImpedanceTestSetStimulationMode.

TABLE 5
Impedance Test Parameters

| Parameter | Value Range | Default Value |
|---|---|---|
| Stimulation Mode | Common Ground (CG), | Common Ground |
| | Monopolar 1 (MP1), | (CG) |
| | Monopolar 2 (MP2), | |
| | Monopolar 1 and 2 | |
| | (MP1 + 2) | |
| Current Level | 0-255 | 100 |
| Phase Width | 400.0 μs | 25.0 μs |
| Electrodes | 1-22, maximum of 22 | 1-22 (inclusive) |
| | electrodes | |

Preferably, the impedance test sequence generator makes use of condition notification to optionally inform the NIC application of certain events. The conditions used by the ImpedanceTest class are detailed in Table 6. The Channel To Be Stimulated condition can be used by the NIC application to provide a progress indicator to the user. The NIC application will receive a Channel To Be Stimulated condition notification for each of the electrodes for which the impedance is being measured.

TABLE 6
Conditions used by the Impedance Test class.

| Condition | Description |
|---|---|
| Channel To Be Stimulated | The NIC application is notified of this |
| | condition immediately prior to each |
| | electrode impedance being measured. |
| Characteristic Data Collected | The telemetry data has been collected, |
| | and the impedance values can now be |
| | retrieved. |
| Sequence End | Sequence processing has ceased, i.e. the |
| | end of the sequence has been |
| | encountered. |

Provided in Listing is some example code which illustrates the use of the impedance test sequence generator.

Listing 12 - Impedance Test Example

```
/* Functions to be invoked by the NIC Library for the three
conditions. */
void UserOnSequenceEnd()
{
    /* Code to be executed on being notified of the Sequence End
condition goes here. */
    ...
}
void UserOnDataCollected()
{
    /* Code to be executed on being notified of the Characteristic
Data Collected
    * condition goes here. */
    ...
}
void UserOnChannelStimulated(Electrode ae, Electrode re)
{
    /* Code to be executed on being notified of the Channel To Be
Stimulated
    * condition goes here. */
    ...
}
/* In application code. Previous to this a CIC3 type implant object
has been selected,
* a sequence object has been created and the communications system
has been
* initialized. */
...
/* Set up the functions which will be called automatically by the NIC
Library when the
* respective condition occurs. */
int error_code = RegisterOnSequenceEndFunction(UserOnSequenceEnd)
if (error_code != 0)
{
    /* The function RegisterOnSequenceEndFunction failed. Notify
the user. */
    fprintf(stderr, “The function RegisterOnSequenceEndFunction()
failed.”);
    ...
}
error_code =
RegisterOnCharacteristicDataCollectedFunction(UserOnDataCollected);
if (error_code != 0)
{
    /* The function RegisterOnCharacteristicDataCollectedFunction
failed. Notify
    * the user. */
    fprintf(stderr,
    “The function RegisterOnCharacteristicDataCollectedFunction()
failed.”);
...
}
error_code =
RegisterOnChannelToBeStimulatedFunction(UserOnChannelStimulated);
if (error_code != 0)
{
    /* The function RegisterOnChannelToBeStimulatedFunction failed.
Notify the user. */
    fprintf(stderr, “The function
RegisterOnChannelToBeStimulatedFunction() failed.”);
    ...
}
/* Create an instance of the ImpedanceTest class. */
IMPEDANCE_TEST* impedance_test = ImpedanceTestNew();
if (!impedance_test)
{
    /* The ImpedanceTestNew function failed. Notify the user. */
    fprintf(stderr, “The function ImpedanceTestNew() failed.”);
    ...
}
/* Set the stimulation mode; MP1+2 is to be used.
error_code = ImpedanceTestSetStimulationMode
(impedance_test, MP1_2)
if (error_code != 0)
{
    /* The function ImpedanceTestSetStimulationMode failed. Notify
the user. */
    fprintf(stderr, “The function ImpedanceTestSetStimulationMode()
failed.”);
    ...
}
/* Set the electrodes to measure impedances on;
* electrodes 1 through 15 are to be used. */
Electrode electrodes_to_measure[15];
for (int i = 0; i < 15; i++)
{
    electrodesToMeasure[i] = i + 1;
}
error_code = ImpedanceTestSetElectrodes(impedance_test, 15,
&electrodes_to_measure)
if (error_code != 0)
{
    /* The function ImpedanceTestSetElectrodesfunction failed.
Notify the user. */
    fprintf(stderr, “The function ImpedanceTestSetElectrodes()
failed.”);
    ...
}
/* Generate the sequence which will measure the electrode impedances.
*/
error_code = ImpedanceTestGenerateSequence
(impedance_test, sequence)
if (error_code != 0)
{
    /* The function ImpedanceTestGenerateSequencefailed. Notify the
user. */
    fprintf(stderr, “The function ImpedanceTestGenerateSequence()
failed.”);
    ...
}
/* Write the sequence into program slot 1 of the speech processor. */
error_code = ImpcommunicatorWriteSequence(sequence, 1);
if (error_code != 0)
{
    /* The function ImpCommunicatorWriteSequence. Notify the user.
*/
    fprintf(stderr, “The function ImpCommunicatorWriteSequence()
failed.”);
    ...
}
/* Set the damp gap system setting to 10.0 us. */
error_code = ImpCommunicatorSetDampGap(10.0);
if (error_code != 0)
{
    /* The function ImpCommunicatorSetDampGap. Notify the user. */
    fprintf(stderr, “The function ImpCommunicatorSetDampGap()
failed.”);
    ...
}
/* Start the sequence in program slot 1; the impedance_test object is
to deal with
* the resulting communication messages. */
error_code = ImpCommunicatorStartSequence(1,
(COMMUNICATIONS_HANDLER*)impedance_test);
if (error_code != 0)
{
    /* The function ImpCommunicatorStartSequence. Notify the user.
*/
    fprintf(stderr, “The function ImpCommunicatorStartSequence()
failed.”);
    ...
}
/* The damp gap setting must be returned to 0.0 us the next time the
function
* ImpCommunicatorStartSequence is invoked. */
...
```

Communication Between Speech Processor and PC

In the preferred embodiment, the communication that occurs between the speech processor and the PC can be broadly separated into two types. The first type is for communications directly instantiated from the PC; this includes sending a sequence image to the speech processor, instructing the command interpreter to start sequence processing, instructing the command interpreter to cease sequence processing, etc. The second type is for communications initiated by the speech processor; this includes messages embedded in a sequence, messages indicating that sequence processing has ceased, etc.

Communication System Initialization and Interface Hardware Selection

The communications component of the NIC Library is initialised with the function ImpCommunicatorInit. In a similar fashion to the implant, frame, sequence and impedance test objects, the destroy function ImpCommunicatorDelete must be invoked once the NIC application has finished using the communications component of the NIC Library. However, the communications component of the NIC Library is a single entity, only one of it can exist at any one time. Also note, that prior to invoking the function ImpCommunicatorInit, a hardware interface type must have previously been selected.

The NIC Library of the present invention can support both types of interface hardware currently available; the Clinical Programming System (CPS) and the Portable Programming System (PPS). Two functions exist in the library to choose between these two types, and also to appropriately configure the respective interface. The function ImpCommunicatorsetCPSConfiguration selects the CPS interface and the base address of the IF5 card, while the function ImpCommunicatorSetPPSConfiguration selects the PPS interface, the communications port and the communications speed.

CPS Interface

To use the CPS hardware interface, the address at which the interface is located in the PC's I/O address space must be specified. The possible addresses that a CPS interface may exist at are 0x100, 0x220, 0x300, or 0x340 (all addresses in hexadecimal). An example of how to initialise the library to use the CPS hardware interface is provided in Listing 13.

Listing 13 - CPS Interface Configuration

```
/* In the application code. */
...
/* The most common address at which the CPS interface is located
is 0x300.
* Though it could as easily be located at 0x100, 0x220 or 0x340. */
int if5_card_address = 0x300;
/* Set the interface type to CPS and set its parameters. */
error_code = ImpCommunicatorSetCPSConfiguration(if5_card_address);
if (error_code != 0)
{
    /* The ImpCommunicatorSetCPSConfiguration function failed.
    Notify the
user. */
    ...
}
/* Now initialise the communications system, which will use the CPS
interface. */
error_code = ImpCommunicatorInit();
if (error_code != 0)
{
    /* The ImpCommunicatorInit function failed. Notify the user. */
    ...
}
/* Further application code. */
...
```

PPS Interface

To use the PPS hardware interface, the communications port at which the interface is connected, and the rate at which it is desired to communicate with the interface, must be specified. The communication ports supported by the library are 1, 2, 3 and 4. The communication rates supported by the library are 9600, 14400, 19200, 28800, 38400, 57600 and 115200. (It is recommended that a communications rate of either 57600 or 115200 is used.) An example of how to initialise the library to use the PPS hardware interface is provided in Listing 14.

Listing 14 - PPS Interface Configuration

```
/* In the application code. */
...
/* The most common port to which the PPS interface is connected is
COM1.
* Though it could as easily be located at COM2, COM3 or COM4. */
int pps_port = 1;
/* The recommended communication rate is either 57600 or 115200. */
int pps_communications_rate = 115200;
/* Set the interface type to CPS and set its parameters. */
error_code = ImpCommunicatorSetPPSConfiguration(pps_port,
pps_communications_rate);
if (error_code != 0)
{
    /* The ImpCommunicatorSetPPSConfiguration function failed.
Notify the user. */
    ...
}
/* Now initialise the communications system, which will use the PPS
interface. */
error_code = ImpCommunicatorInit();
if (error_code != 0)
{
    /* The ImpCommunicatorInit function failed. Notify the user. */
    ...
}
/* Further application code. */
...
```

Initiating Communications

Table 7 details the functions that the NIC Library provides to manage the initiation and cessation of communications.

TABLE 7
Communication Initiation and Cessation Functions

| | |
|---|---|
| Function | Description |

| | |
|---|---|
| ImpCommunicatorConnect | Initiates communications with the |
| | speech processor. The function fails if |
| | the correct version of command |
| | interpreter software is not |
| | present in the speech processor. |
| ImpCommunicatorForceConnect | Initiates communications with the |
| | speech processor. The function |
| | automatically downloads the correct |
| | version of the command interpreter |
| | software. This action will erase all |
| | previous data residing in the |
| | speech processor. |
| ImpCommunicatorDisconnect | Ceases communications between the |
| | speech processor and the PC, and |
| | removes power from the |
| | speech processor. |
| ImpCommunicatorReset | Resets the hardware interface; power is |
| | removed from the speech processor and |
| | then reapplied. |

The difference that exists between the functions ImpCommunicator Connect and ImpCommunicatorForceConnect is so that the NIC application can warn the user that the speech processor's memory contents will be lost if it is to continue. If the speech processor is not connected to the hardware interface then both ImpCommunicatorConnect and ImpCommunicatorForceConnect functions will fail. Listing 15 provides an example of this process.

Listing 15 - Initiating Communications Example

```
/* The CPS is being used. */
int error_code = ImpCommunicatorSetCPSConfiguration(0x300);
if (error_code != 0)
{
    /* The ImpCommunicatorSetCPSConfiguration function failed,
something is wrong with
    * the hardware interface. Notify the user. */
    ...
}
/* Initialize the communications system. */
error_code = ImpCommunicatorInit();
if (error_code != 0)
{
    /* The ImpCommunicatorInit function failed, something is wrong
with the hardware
    * interface. Notify the user. */
    ...
}
/* Initiate communications with the hardware system. */
error_code = ImpCommunicatorConnect();
if (error_code != 0)
{
    /* Either the correct version of command interpreter software is
not present
    * in the speech processor, or the speech processor is not
connected. */
    error_code = ImpCommunicatorForceConnect();
    if (error_code != 0)
    {
        /* The speech processor is not connected to the hardware.
Notify the user. */
        ...
    }
}
/* Further application processing goes here. */
...
// Cease communications with the speech processor.
ImpCommunicatorDisconnect();
```

Communication Functions for Sequences

Table 8 details the functions that the NIC Library provides to manage the communications dealing with sequences and Listing 16 provides some example code of sequence handling communications.

TABLE 8
Sequence Communication Functions

| Function | Description |
|---|---|
| ImpCommunicatorReadSequence | Reads a sequence from the program |
| | processor. |
| ImpCommunicatorWriteSequence | Writes a sequence into the program |
| | slot specified in the speech |
| | processor. All sequence image |
| | handling is performed automatically |
| | as part of this function. It is |
| | not necessary to invoke the function |
| | ImpCommunicatorClearSequence |
| | before writing a new sequence |
| | into a program slot. |
| ImpCommunicatorClearSequence | Erases a sequence from the program |
| | slot specified in the speech |
| | processor. |
| ImpCommunicatorStartSequence | Instructs the speech processor to start |
| | sequence processing. |
| ImpCommunicatorStopSequence | Instructs the speech processor |
| | to cease sequence processing. |
| | This function is guaranteed |
| | to perform it's action regardless |
| | of the state of the system, for |
| | safety reasons. The NIC application |
| | can specify whether the implant is |
| | to remain powered. |

Listing 16 - Communications Dealing with Sequences

```
/* The sequence object has previously been set up and communications
has already
* been initiated.*/
...
// Write the constructed sequence into program slot 1 on the speech
processor.
error_code = ImpCommunicatorWriteSequence(sequence, 1);
if (error_code != 0)
{
    /* The function ImpCommunicatorWriteSequence failed. Notify the
user. */
    ...
}
// Start processing the sequence in program slot 1.
error_code = ImpCommunicatorStartSequence(1);
if (error_code != 0)
{
    /* The function ImpCommunicatorStartSequence failed. Notify the
user. */
    ...
}
// Further application processing goes here.
...
/* For whatever reason, the sequence processing is to be stopped. The
parameter
* keep_powered_up is a Boolean parameter previously set by the user.
*/
error_code = ImpCommunicatorStopSequece(true);
if (error_code != 0)
{
    /* The function ImpCommunicatorStopSequece failed. Notify the
user. */
    ...
}
```

Speech Processor Parameter Communications

Table 9 details the functions that the NIC Library provides to manage the speech processor operational parameters.

TABLE 9
Speech Processor Parameters Communication Functions

| Function | Description |
|---|---|
| ImpCommunicatorSetDampGap | Sets the time interval between the |
| | falling edge of the frame RF and the |
| | time at which the telemetry receive |
| | circuitry is enabled. This should always |
| | be set to 0 μs when telemetry is |
| | not being received, and a value of 10 μs |
| | when telemetry is to be received |
| | (e.g. the impedance test sequence |
| | generator). This function should be |
| | called immediately before the function |
| | ImpCommunicatorStartSequence. |
| ImpCommunicatorSetTeleDAC | Sets the trigger level of the DAC in the |
| | telemetry receive circuitry. The system |
| | uses a sensible default value, and so this |
| | function should only be used under |
| | extenuating circumstances |
| ImpCommunicatorSetTransmit | Sets the transmit voltage to be used |
| Voltage | by the RF output stage of the speech |
| | processor. The range of available |
| | voltages is 2400 mV-3400 mV |
| | inclusive. The system uses the |
| | value of 3400 mV by default. |
| ImpCommunicatorGetTransmit | Retrieves the current transmit voltage |
| Voltage | used by the RF output stage of the |
| | speech processor. |

Miscellaneous Functions

Finally, Table 10 details the miscellaneous communication functions provided by the NIC Library.

TABLE 10
Miscellaneous Communication Functions

| Function | Description |
|---|---|
| ImpCommunicatorGetSPrintSupervisorVersion | Retrieves the version of |
| | the command interpreter |
| | software from the speech |
| | processor. |
| | Communications must |
| | have been initiated |
| | between the PC and |
| | the speech processor |
| | before this |
| | function can be invoked. |
| ImpCommunicatorGetFileSupervisorVersion | Retrieves the version of |
| | the command interpreter |
| | software present on the |
| | hard disk. This function |
| | can be called at any time. |
| ImpCommunicatorGetRevisionNumber | Retrieves the version of |
| | the NIC Library. |

Condition Notification

A condition is an internal change of state in the NIC Library, which may be of interest to the NIC application. Generally the conditions indicate that a communications message has been received from the speech processor, however, a number of the conditions indicate more than just this. The conditions that currently exist in the NIC Library are detailed in Table 11. The condition notification interface allow the NIC application to “register” a function that will automatically be invoked by the NIC Library when the condition occurs. These register functions take the format: RegisterOnxxxxFunction, where xxxx is the condition name; e.g. for the Channel To Be Stimulated condition, the register function is RegisterOnChannelToBeStimulatedFunction. If the NIC application does not want to be notified of the condition, then a function should not be registered for it.

TABLE 11
Conditions in the NIC Library

| Condition | Description |
|---|---|
| ImplantNoResponse | The speech processor has lost |
| | communication with the implant. This |
| | only occurs if telemetry is being |
| | performed. |
| ComplianceDataCollected | Compliance telemetry data has been |
| | collected and processed. The result of |
| | the measurements can now be |
| | retrieved. |
| CharacteristicDatacollected | Implant characteristic telemetry data has |
| | been collected and processed. The result |
| | of the measurements can now be |
| | retrieved. |
| NRTDataCollected | NRT data has been collected and |
| | processed. The result of the |
| | measurements can now be |
| | retrieved. For NRT use only |
| CommunicationsErrorCondition | An error has occurred with the |
| | communications system. |
| CalibrationDataCollected | Data from an implant calibration |
| | sequence has been collected and |
| | processed. The result of the |
| | measurements can now be |
| | retrieved. |
| ChannelToBeStimulated | A channel is about to be stimulated. |
| | Data is provided as part of the |
| | notification detailing the electrodes |
| | of the channel. |
| SufficientSweeps | The requested number of sweeps has |
| | been completed; a sweep being one |
| | set of stimulation frames. |
| SequenceEnd | The end of the sequence has been |
| | processed. |

The most typical example of an NIC application using a condition, is when it wants to be notified of the cessation of sequence processing; the Sequence End condition. Code to illustrate such an example is provided in Listing 17.

void UserOnSequenceEndFunction( )

Listing 17 - Condition Notification Example

```
{
    /* This function will be automatically invoked when the end of a
sequence is
    * encountered. Do whatever processing needs to be done for the
condition
    * here. */
    ...
}
/* In the application code. */
...
/* Register the function UserOnSequenceEndFunction with the NIC
Library, so that it
* will be automatically invoked when the sequence has finished being
processed. */
if (!RegisterOnSequenceEndFunction(UserOnSequenceEndFunction))
{
    /* The RegisterOnSequenceEndFunction function failed. Notify
the user. */
fprintf(stderr, “The function RegisterOnSequenceEndFunction()
failed.\n”);
    return;
}
/* Further application code as required. */
...
/* Start a sequence that has previously been written into program slot
5 of the
* speech processor. */
if (!ImpCommunicatorStartSequence(5))
{
    /* The ImpCommunicatorStartSequence function failed. Notify the
user. */
fprintf(stderr, “The function ImpCommunicatorStartSequence()
failed.\n”);
    return;
}
/* Now the function UserOnSequenceEndFunction will be invoked
automatically by the
* NIC Library when the sequence processing has finished. */
...
```

Sync Pulse Creation

A sync pulse is a signal generated by the hardware interface (either CPS or PPS) at a certain time during the sequence execution, which is used to trigger a piece of external equipment. This type of functionality is useful if it is desired to observe part of the stimulus pattern, or if a response from the implant recipient, to a stimulus pattern, is to be observed. Typically a Digital Storage Oscilloscope (DSO) would be used in the case of the former, while an Evoked Arbitrary Brainstem Response (EABR) recording machine would be used in the case of the later.

Syncs with the PPS Interface

Two modes of sync signal generation are available for when the PPS hardware interface is used (this does not include the option of not generating sync pulses). These modes are:

a sync pulse is generated at the leading edge of every RF frame;

the sync pulse generation circuitry can be enable and disabled by sending communication messages from the speech processor to the hardware interface. When the circuitry is enabled, a sync pulse is generated at the leading edge of every RF frame. This mode is known as gated sync pulse generation.

Depending upon the use for the sync pulse, the second option for sync pulse generation is often more useful that the first option. The mode of operation for the sync generation functionality is set using the function ImpCommunicatorSetSyncPulseType. This function takes an integer to indicate which mode the sync generation circuitry is to operate in; the values currently used are as follows:

TABLE 12
PPS Sync Modes

| Sync mode description | Parameter value |
|---|---|
| No sync pulses | 0 |
| Gated sync pulse generation | 1 |
| Sync pulses on every RF frame | 5 |

Creating a sequence with syncs pulses will produce different results depending on the protocol used. For the embedded protocol, the sync pulse messages must be placed around the frame, two frames after the desired frame to sync on. The two frame offset is due to a one frame offset in the embedded protocol and a one frame offset in the internal processing of the command interpreter. For the expanded protocol (ie. a protocol that encodes the frame parameters as the lengths of RF bursts), the sync pulse messages must be placed around the frame, one frame after the desired frame to sync on. The one frame offset is due only to the one frame offset in the internal processing of the command interpreter.

In order to send the communications message to enable or disable the sync pulse generation circuitry in the hardware interface, the function ImpSequenceAppendSendCommsMessage should be used; the communications message for enabling the circuitry is ENABLE_PPS2_SYNC_PULSES, whilst for disabling the circuitry the communications message is DISABLE_PPS2_SYNC_PULSES.

A sequence created with the purpose of generating sync pulses using the PPS hardware interface, can also be used with the CPS interface, though no sync pulses will be generated. The library has been designed to ignore the communications messages, which would normally enable and disable the sync pulse generation circuitry in the PPS, in this situation.

Embedded Protocol Example

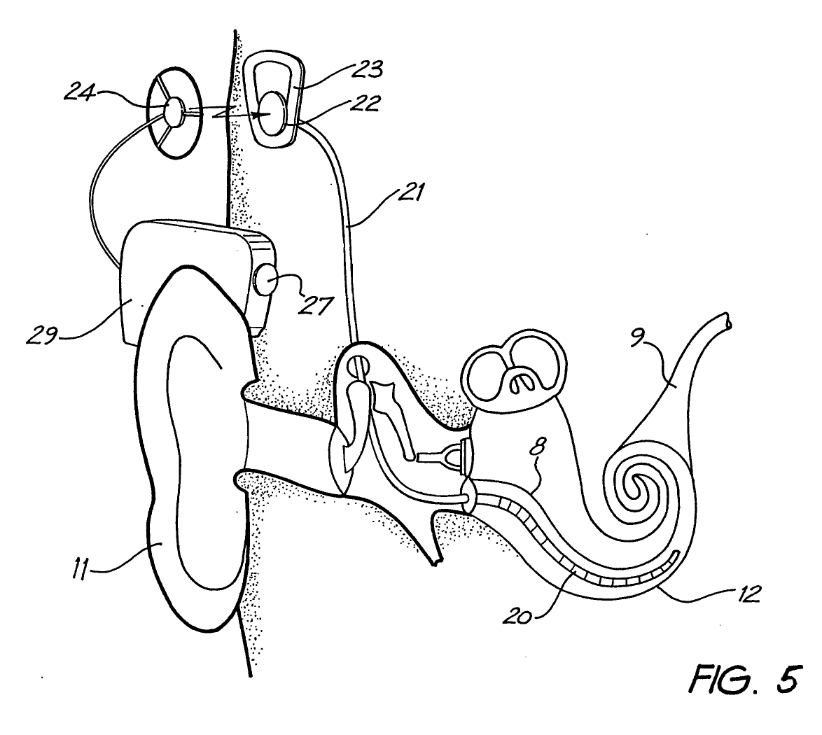

For the purpose of the example, a sync signal is to be generated so that the details of a certain stimulus frame can be captured; FIG. 4 details the exact timing. The aim then, is to create a sequence with 4 identical stimulus frames, where a sync pulse is only generated for the 2^{nd} stimulus frame. Application code that would produce this desired response is detailed in Listing (note how the PPS messages are actually before and after the 4^{th} frame in the sequence, not the 2^{nd}).

Listing 18 - Embedded Protocol Sync Example

/* The frame period is set to 1000.0us, thus allowing for the 400.0us
* activation and deactivation time inherent with the PPS sync pulse
* generation circuitry (in gated sync pulse mode). */
ImpFrameSetPeriod(frame, 1000.0);
ImpSequenceAppendFrame(sequence, frame); // first frame
ImpSequenceAppendFrame(sequence, frame); // second frame
ImpSequenceAppendFrame(sequence, frame); // third frame
// This message will enable syncs for the second frame.
ImpSequenceAppendSendCommsMessage(sequence,
SP5_ENABLE_PPS2_SYNC_PULSES);
ImpSequenceAppendFrame(sequence, frame); // fourth frame
// This message will disable syncs for the second frame.
ImpSequenceAppendSendCommsMessage(sequence,
SP5_DISABLE_PPS2_SYNC_PULSES);

Expanded Protocol Example

The desired response from the system is the same as that above, but using the expanded protocol. The application code is detailed in Listing 19 (note how the PPS messages are actually before and after the 3^{rd} frame in the sequence, not the 2^{nd}).

Listing 19 - Expanded Protocol Sync Example

// The frame period is set to 1000.0us, thus allowing for the 400.0us
// activation and deactivation time inherent with the PPS sync pulse
// generation circuitry (in gated sync pulse mode).
ImpFrameSetPeriod(frame, 1000.0);
ImpSequenceAppendFrame(sequence, frame); // first frame
ImpSequenceAppendFrame(sequence, frame); // second frame
// This message will enable syncs for the second frame.
ImpSequenceAppendSendCommsMessage(sequence,
SP5_ENABLE_PPS2_SYNC_PULSES);
ImpSequenceAppendFrame(sequence, frame); // third frame
// This message will disable syncs for the second frame.
ImpSequenceAppendSendCommsMessage(sequence,
SP5_DISABLE_PPS2_SYNC_PULSES);
ImpSequenceAppendFrame(sequence, frame); // fourth frame

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A software library comprising a plurality of predetermined software modules, each software module defining instructions for control of a tissue-stimulating prosthesis.

2. The software library according to claim 1 wherein the instructions define a stimulus pattern to be generated by the prosthesis.

3. The software library according to claim 1 or claim 2 wherein the instructions are for control of acquisition of telemetry data by the prosthesis.

4. The software library according to any one of claims 1 to 3 wherein the instructions relate to communication of data from the prosthesis.

5. The software library according to any preceding claim wherein the tissue-stimulating prosthesis is an implantable prosthesis.

6. The software library according to claim 5 wherein the tissue-stimulating prosthesis is a cochlear implant.

7. The software library according to any preceding claim wherein a software module of the software library is based on a data frame for transmission to the prosthesis.

8. The software library according to claim 7 wherein the data frame is a stimulus frame.

9. The software library according to claim 7 wherein the data frame is a non-stimulus frame that specifies an implant command.

10. The software library according to claim 9 wherein the non-stimulus frame is a telemetry command.

11. The software library according to claim 10 wherein the software module further comprises a trigger command to trigger operation of telemetry equipment external to the processing means.

12. The software library according to any one of claims 7 to 11 wherein a data frame of a software module of the software library specifies simultaneous stimulations to be output by a plurality of electrodes of the implant.

13. The software library according to any preceding claim wherein a software module requires a user input of at least one variable selected from: electrode(s) to be stimulated; reference electrode; stimulus level; pulse phase width; phase gap; and stimulus frame period.

14. The software library according to any preceding claim wherein a software module of the software library comprises a sequence of data frames for streamed delivery to the prosthesis.

15. The software library according to any preceding claim wherein the library comprises a plurality of classes of software modules, wherein each class of software module is applicable to a particular model of prosthesis.

16. The software library of any preceding claim wherein the software library is a dynamic link library (DLL).

17. A communication means for communicating with a tissue-stimulating prosthesis, the communication means being operable to output a software command set to the prosthesis for causing the prosthesis to generate a stimulation pattern, the communication means including a library of predetermined software modules for use in the creation of the software command set.

18. The communication means according to claim 17 wherein the tissue-stimulating prosthesis is an implantable prosthesis.

19. The communication means according to claim 18 wherein the tissue-stimulating prosthesis is a cochlear implant.

20. The communication means according to any one of claims 17 to 19 wherein the communication means is a personal computer (PC).

21. The communication means according to claim 20 wherein the personal computer is operable to present a graphical user interface (GUI) that allows a user to provide instructions to the communication means.

22. The communication means of claim 21 wherein the instructions specify parameters of the modules stored in the library.

23. The communication means of claim 21 or 22 wherein the instructions can be entered by use of one or more of a keyboard, a mouse, a touchpad, and a joystick.

24. The communication means of any one of claims 17 to 23 further comprising a hardware interface for communication of the software command set to the tissue-stimulating prosthesis.

25. The communication means according to any one of claims 17 to 24 wherein a software module of the software library is based on a data frame for transmission to the prosthesis.

26. The communication means according to claim 25 wherein the data frame is a stimulus frame.

27. The communication means according to claim 25 wherein the data frame is a non-stimulus frame that specifies an implant command.

28. The communication means according to claim 27 wherein the non-stimulus frame is a telemetry command.

29. The communication means according to claim 28 wherein the software module further comprises a trigger command to trigger operation of telemetry equipment external to the processing means.

30. The communication means according to any one of claims 25 to 29 wherein a data frame of a software module of the library specifies simultaneous stimulations to be output by a plurality of electrodes of the implant.

31. The communication means according to any one of claims 17 to 30 wherein a software module of the library requires a user input of at least one variable selected from: electrode(s) to be stimulated; reference electrode; stimulus level; pulse phase width; phase gap; and stimulus frame period.

32. The communication means according to any one of claims 17 to 31 wherein a software module of the software library comprises a sequence of data frames for streamed delivery to the prosthesis.

33. The communication means according to any one of claims 17 to 32 wherein the library comprises a plurality of classes of software modules, and wherein each class of software module is applicable to a particular model of prosthesis.

34. The communication means according to any one of claims 17 to 33 wherein the library is a dynamic link library (DLL).

35. The communication means of any one of claims 17 to 34 further comprising a sequence generator to produce a ready-made sequence of frames for a specific purpose.

36. The communication means according to claim 35 wherein the sequence generator is a psychophysics sequence generator which generates a sequence based on an input comprising at least one of: timing of burst duration, inter-burst gap, and number of bursts.

37. The communication means according to claim 35 or claim 36 wherein the sequence generator is operable to store a generated sequence as a software module in the library.

38. The communication means according to any one of claims 17 to 37 further comprising a library interface means which can be used by a user to construct a sequence of frames.

39. The communication means according to any one of claims 17 to 38, wherein the communication means is operable to communicate the software command set to the memory of a processor of the implant.

40. The communication means according to any one of claims 17 to 39, wherein the communication means is operable to communicate the software command set directly to the prosthesis.

41. The communication means of claim 40 wherein the communication means supports off-line processing of a stimulus, prior to generation of a software command set based on said stimulus for communication directly to the prosthesis.

42. A storage means storing in machine readable digital form a plurality of software modules, each software module defining instructions for control of a tissue-stimulating prosthesis.

43. The storage means according to claim 42 wherein the instructions define a stimulus pattern to be generated by the prosthesis.

44. The storage means according to claim 42 or claim 43 wherein the instructions are for control of acquisition of telemetry data by the prosthesis.

45. The storage means according to any one of claims 42 to 44 wherein the instructions relate to communication of data from the prosthesis.

46. The storage means according to any one of claims 42 to 45 wherein the tissue-stimulating prosthesis is an implantable prosthesis.

47. The storage means according to claim 46 wherein the tissue-stimulating prosthesis is a cochlear implant.

48. The storage means according to any one of claims 42 to 47 wherein at least one software module is based on a data frame for transmission to the prosthesis.

49. The storage means according to claim 48 wherein the data frame is a stimulus frame.

50. The storage means according to claim 48 wherein the data frame is a non-stimulus frame that specifies an implant command.

51. The storage means according to claim 50 wherein the non-stimulus frame is a telemetry command.

52. The storage means according to claim 51 wherein the at least one software module further comprises a trigger command to trigger operation of telemetry equipment.

53. The storage means according to any one of claims 42 to 52 wherein a data frame of at least one software module specifies simultaneous stimulations to be output by the implant.

54. The storage means according to any one of claims 42 to 53 wherein at least one software module requires a user input of at least one variable selected from: electrode(s) to be stimulated; reference electrode; stimulus level; pulse phase width; phase gap; and stimulus frame period.

55. The storage means according to any one of claims 42 to 54 wherein a software module comprises a sequence of data frames for streamed delivery to the prosthesis.

56. The storage means according to any one of claims 42 to 55 wherein each software module is a member of a class, wherein each class of software module is applicable to a particular model of prosthesis.

57. The storage means of any one of claims 52 to 56 wherein the software modules form a dynamic link library (DLL).

58. A cochlear implant communicator operable to present an interface for receiving instructions from a user, and operable to call upon functions within a stored communicator library, wherein said functions are operable to control a tissue-stimulating implanted prosthesis in accordance with the instructions received from the user, and wherein said instructions do not require intricate knowledge of the implant's construction and performance.

59. A method for controlling a tissue-stimulating prosthesis, the method comprising the steps of:
receiving user instructions specifying a desired action of the prosthesis; and
accessing a library of predetermined software modules in order to build a software command set for causing the prosthesis to perform the desired action.

60. The method of claim 59 further comprising the steps of:
building the software command set using standard ranges for each variable value;
communicating the software command set to a processor of the prosthesis; and
subsequent to said step of communicating, mapping the value of each variable from the standard range to a recipient-specific range.

61. The method of claim 60 wherein the variable is stimulus amplitude, and the recipient-specific range is defined by a minimum threshold (T level) and a maximum comfort (C level) of the prosthesis recipient.

62. A system for controlling a tissue-stimulating prosthesis comprising:
a communication means in accordance with any one of claims 17 to 41; and
a processor for receiving the software command set from the communication means, processing the software command set, and delivering hardware instructions to control the prosthesis in accordance with the software command set.

63. A method for controlling a tissue-stimulating prosthesis, the method comprising the steps of:
receiving arbitrary user instructions specifying a desired action of the prosthesis; and
accessing a library of predetermined software modules in order to allow said arbitrary user instructions to be performed by the prosthesis to perform said desired action.
